(19) United States
(12) Patent Application Publication
(10) Pub. No.: US 2016/0169486 A1
(43) Pub. Date: Jun. 16, 2016

(54) TRACK LIGHTING MODULE SHROUD

(71) Applicant: GE Lighting Solutions, LLC, East Cleveland, OH (US)

(72) Inventors: Ashbeel Younas JOHN, Montreal (CA); Veronika VARGA, Budapest (HU)

(21) Appl. No.: 14/572,588

(22) Filed: Dec. 16, 2014

(51) Int. Cl. F21V 17/06; F21V 15/01; F21V 29/83; F21S 8/06; F21V 29/74

(52) U.S. Cl. CPC F21V 17/06; F21S 8/066; F21V 29/74; F21V 29/83; F21V 15/01; F21Y 2101/02

(57) ABSTRACT

A track lighting module shroud includes a shell defining an interior volume, the shell including first and second edges at opposing ends of the shell, the shell including a mount opening through the shell, the mount opening configured to align the shell with features of an LED track lighting luminaire, the LED track lighting luminaire including an LED light head having a heat sink, and the interior volume sized to accommodate the heat sink.

### BACKGROUND

Track lighting fixtures have broad applications in both commercial and residential applications. In commercial retail space lighting designs, lighting tracks can be placed where desired so that a track lighting luminaire can be placed accommodate changes to merchandise displays. A conventional light emitting diode (LED) track luminaire can include a LED light head mounted to a LED driver box. The light head can be re-orientated with respect to the driver box so as to direct light towards a particular location. A LED light head can include a passively cooled heat sink having exposed fins for thermal dissipation. Though aesthetically designed, exposed fins are unpleasing to some customers.

In general retailers strive to differentiate their store from competitors. These differentiators can include not only merchandise and pricing, but also the “look and feel” of the store itself Chain store retailers expend effort and expenses to have a brand identity that is consistent from one location to another within the chain so that customers have the same shopping experience at each location. In particular, retailers request to have differentiators for the track lighting fixtures used in their locations to set the stores apart from their competitors' stores.

To provide this differentiation, fixture manufacturers offer a large portfolio of products to fulfill fixture design needs. Fixture manufacturers typically develop a custom-designed solution to help brand the retailers' location(s). These custom-designed solutions can lead to multiple fixture family designs over the years. Some differentiators can include different luminaire accessory options (e.g., various designs for the snoot, louver, color filters, etc.). To provide these differentiators, one or more of the customized parts need to have die-cast molds created, resulting in high investment costs for each of the fixture design families. For example, to hide the heat sink fins fixture manufacturers typically go with molded or die-cast pieces requiring additional engineering/ molding expenses for each variation.

Execution of multiple track light families can be a multi-year development for manufacturers, with high investment costs and long lead times. Use of molded or die-cast pieces for accessory mounting can be an expensive and intensive investment of manpower, resources, and time.

### BRIEF DESCRIPTION OF THE DRAWINGS

FIG. 1 depicts a conventional LED track lighting luminaire;

FIG. 2 depicts a track lighting module shroud in accordance with some embodiments;

FIGS. 3A-B depict the track lighting module shroud of FIG. 2 prior to assembly in accordance with some embodiments;

FIG. 4 depicts a track lighting module shroud mounted on an LED track lighting luminaire in accordance with some embodiments; and

FIG. 5 depicts a track lighting module shroud mounted on an LED track lighting luminaire in accordance with some other embodiments.

### DESCRIPTION

In accordance with embodiments, a track lighting module shroud (“shroud”) can be used in combination with a track lighting luminaire to provide a customized appearance to the track lighting luminaire. In accordance with implementations, the shroud can be a shell that accommodates within an interior region a heat sink of a light head. The shell can include alignment features that align the shell with portions of the LED track lighting luminaire to mount the shroud to the luminaire. The shroud can be customized to meet design details provided by an end user (e.g., a retail store operator). The customized look of the shroud can contribute to the overall look and feel of a retail location to distinguish that location from competitors' locations.

The shroud can be mounted on a standardized track lighting luminaire so that the luminaire's manufacturer can realize cost savings and economies-of-scale associated with producing a minimum number of variations. By combining this standardized track lighting luminaire with the shroud, the manufacturer is able to offer its customers virtually limitless variations of appearances without expending the manpower, resources, and time usually associated with providing broad product variations.

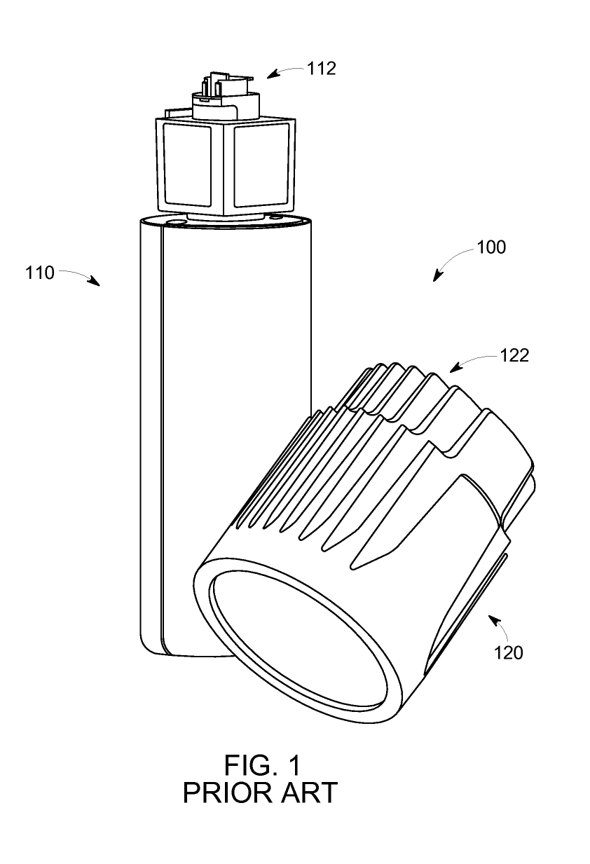

FIG. 1 depicts conventional LED track lighting luminaire 100 which includes LED driver box 110 and LED light head 120. The driver box is connectable to a track mounted on a surface (e.g., wall or ceiling) via connector 112. The connector provides power to the driver electronics inside the driver box. LED driver box 110 is a vertical driver box, meaning that the body of the driver box is positioned perpendicular to the surface on which the track is mounted. Embodying shrouds are not limited to just vertical driver boxes, but can equally be implemented for horizontal driver boxes (i.e., the driver box is parallel to the track's mounting surface).

In some implementations the light head is pivotably mounted so that its position can be altered to direct light unto different surfaces. The LED light head can have a mounting arrangement that includes a pin, bolt, rod, etc. In some implementations, the light head can rotate about a pivot point located at about a centerline of the pin, bolt, rod, etc. In some implementations the light head can be pivotably mounted to a driver box, or to a mounting yolk. LED light head 120 includes heat sink 122 to passively conduct heat away from the LED light source contained within the light head. In some implementations the heat sink can be extruded, or die cast formed on an exterior shell of the light head. In some embodiments, the shroud and heat sink can be extruded together.

Embodying shrouds can be assembled to an LED track lighting luminaire. In particular, the shroud can be positioned over the LED light head to provide a different appearance for the LED track lighting luminaire. In accordance with embodiments, the shroud can be assembled with the LED track lighting luminaire either at a manufacturer's facility, or in the field (e.g., during installation at an end user's location).

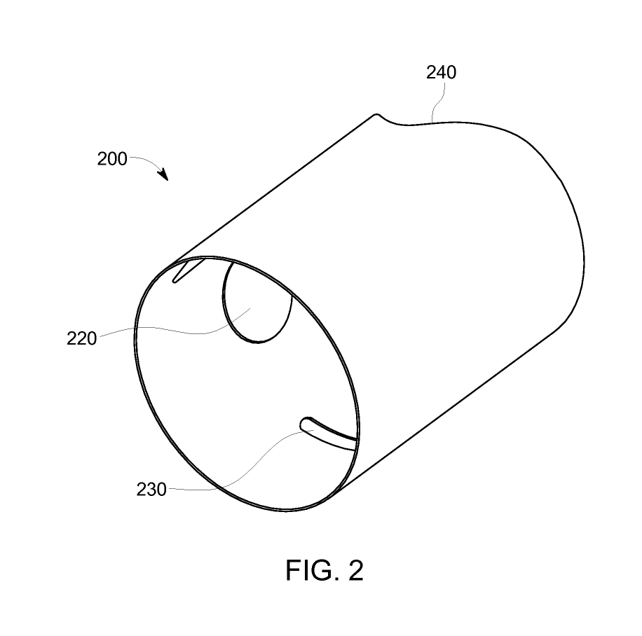

FIG. 2 depicts track lighting module shroud 200 in accordance with some embodiments. In some implementations, shroud 200 can have an overall cylindrical shape. However embodying shrouds are not so limited, and in some implementations can have oval, square and even irregular cross sectional shapes. Shroud 200 includes mount opening 220 which is structured and sized to provide a mounting interface for the shroud. The mount opening aligns the shroud with the light head. The overall diameter of shroud 200 can be sized to accommodate the outer dimension of the heat sink.

In some implementations the mount opening corresponds in position with the mounting arrangement for the light head of the luminaire. Mount opening 220 can accept the pivotable mount for the light head prior to assembly of the light head. Mount opening 220 can have an overall diameter to accommodate the light head mounting arrangement. In some implementations the light head can be pivotably connected to the driver box. In other implementations, the driver box can be remotely located from the light head—for example, a direct current voltage can be provided to the light head by the track system. In these other implementations, the light head can be pivotably connected to a mounting yolk or other support. Embodying shrouds include a mount opening corresponding to any configuration of the light head mounting arrangement.

The shroud also can include one or more air inlet(s) 230 located towards one end of the shroud. An end of the shroud distal from the air inlet(s) can be scalloped (i.e., having an irregular shape) to provide thermal exit(s) 240. The air inlet and thermal exit(s) can create an air flow where air is drawn in through air inlet(s) 230 and expelled through thermal exit(s) 240 by convection to remove at least a portion of the heat along the heat sink of the light head.

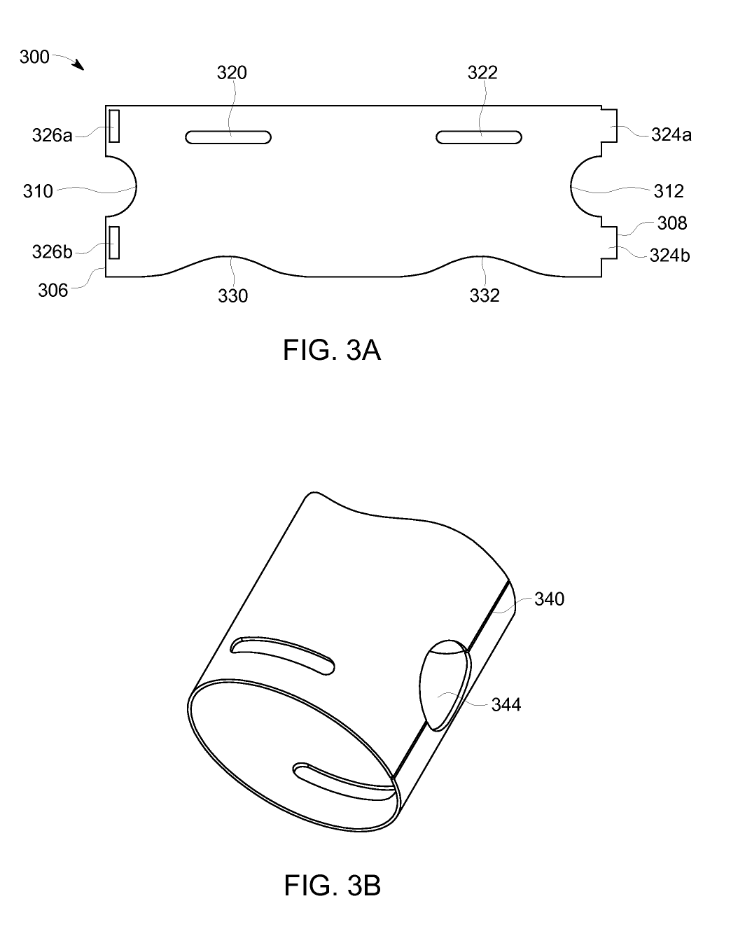

FIG. 3A depicts shroud 300 prior to assembly in accordance with some embodiments. Shroud 300 could be formed from a sheet metal piece which has features stamped and/or cut out. The shroud can be shaped by rolling, or bending, the sheet metal piece and fastening, and/or joining, two opposing ends by welding, mechanical tabs, rivets, etc. When the shroud is shaped and the two opposing ends are fastened the shroud defines an interior volume that is sized to accommodate the light head of the LED track lighting luminaire.

Shroud 300 can include cut-outs 310, 312 along opposing edges 306, 308. Although cut-outs 310, 312 are depicted as semicircular, other shapes can be implemented. Shroud 300 also includes air inlets 320, 322 and thermal exits 330, 332 along an edge distal from the air inlet locations. When the two opposing edges of the shroud are joined, and/or fastened, cut-outs 310, 312 form the mount opening that aligns the shroud with the features of the LED track lighting luminaire.

In accordance with embodying implementations, the shroud can be formed from a polymer, a thermally-conductive polymer, and other materials capable of being in proximity to the heat generated by the passive heat sinks of the LED track lighting luminaire. A polymer, or plastic, shroud can also be formed by rolling or bending. Additionally, embodying polymer, or plastic, shrouds can be formed by the use of pre-formed molds.

In some embodiments, shroud 300 can also include one or more tabs 324A, 324B and slots 326A, 326B. These tabs and slots are on opposing sides of the shroud and can be used to hold the shroud to its final shape after the sheet metal is rolled or bent. As described above, the shroud can be aligned and held in place using features of the LED track lighting luminaire—e.g., where the light head mounts to the driver box or a mounting yolk. FIG. 3B depicts shroud 300 after being formed by rolling or bending. The shroud is fastened along edges 306, 308 to form seam 340. Further mount opening 344 is formed by the alignment of cut-outs 310, 312.

In other implementations, the shroud can be further customized to meet customer-specific appearances (e.g., color, logo, printing, etc.). The shroud can also include accessorizing mount mechanisms (e.g., tabs, slots, protrusions, and/or openings) that accept accessories that mount to the luminaire (e.g., optical covers, Hexcel Louver, color filters, trim pieces, etc.).

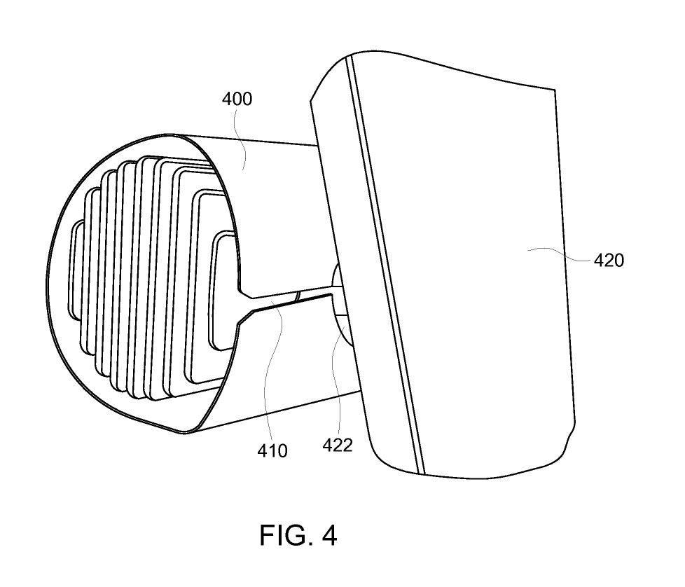

The shroud could have the option of being a design that can be assembled onto the track lighting luminaire after it is assembled. FIG. 4 depicts track lighting module shroud 400 mounted on an LED track lighting luminaire in accordance with some embodiments. Shroud 400 includes a seam with opposing edges that are spaced apart to form opening 410. Opening 410 is sized to accommodate installation of shroud 400 onto the LED track lighting luminaire after the heat sink is mounted to driver box 420. The opening can be sized to fit around pivotable mount 422, where the light head and driver box are joined, so that the shroud can be held in place.

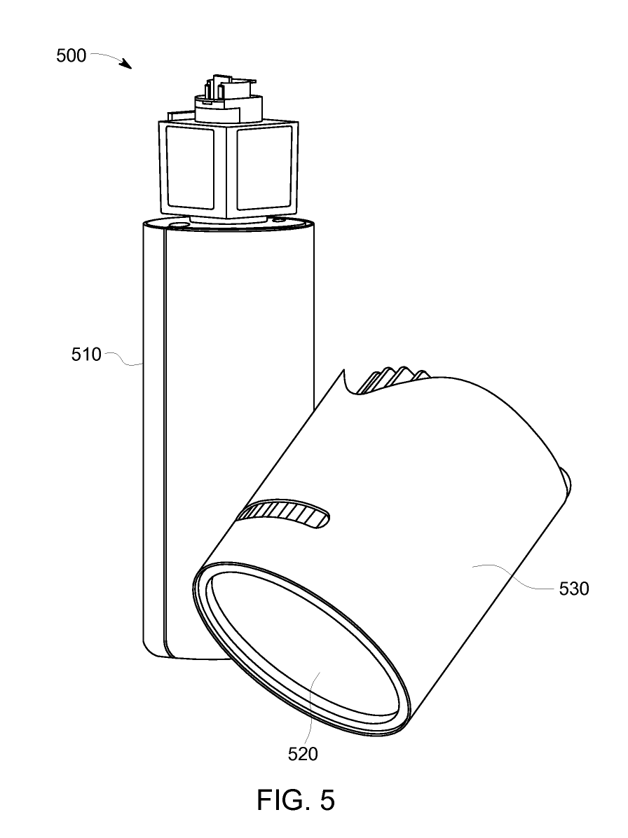

FIG. 5 depicts track lighting module shroud 530 mounted on LED track lighting luminaire 500 which includes light head 530 and driver box 510. The shroud is mounted by positioning around the pivotable mounting connection between the light head and the driver box. The shroud is sized to accommodate the light head within its interior. Air inlets in combination with thermal exits on the shroud allow for airflow along the fins of the light head's heat sink. This airflow assists the heat sink to transfer heat away from the LED light source within the light head. The air inlets, thermal exits, and interior volume of the shroud are configured to maintain a rate of heat extraction suitable to maintain the heat within the light head to be below the critical and/or maximum operating temperature of the light head. In other implementations, the shroud can include accessorizing mount mechanisms (e.g., tabs, slots, protrusions, and/or openings) that accept optical covers 520 and/or other accessories that mount to the luminaire (e.g., Hexcel Louver, color filters, trim pieces, etc.).

Although specific hardware and methods have been described herein, note that any number of other configurations may be provided in accordance with embodiments of the invention. Thus, while there have been shown, described, and pointed out fundamental novel features, it will be understood that various omissions, substitutions, and changes in the form and details of the illustrated embodiments, and in their operation, may be made by those skilled in the art without departing from the spirit and scope of the invention. Substitutions of elements from one embodiment to another are also fully intended and contemplated.

1. A track lighting module shroud comprising:
a shell defining an interior volume, the shell including first and second edges at opposing ends of the shell;
the shell including a mount opening through the shell, the mount opening configured to align the shell with features of an LED track lighting luminaire, the LED track lighting luminaire including an LED light head having a heat sink; and
the interior volume sized to accommodate the heat sink.

2. The track lighting module shroud of claim 1, including an air inlet formed proximal to the first edge.

3. The track lighting module shroud of claim 1, including a thermal exit distal from the air inlet.

4. The track lighting module shroud of claim 2, including a thermal exit formed along the second edge.

5. The track lighting module shroud of claim 1, the mount opening located at a position on the shell that corresponds to a mounting arrangement of the LED light head.

6. The track lighting module shroud of claim 1, including a seam portion with opposing edges spaced apart at a distance configured to accept a mounting arrangement of the LED light head.

7. The track lighting module shroud of claim 1, the shell formed from sheet metal.

8. The track lighting module shroud of claim 1, the shell formed from a polymer.

9. The track lighting module shroud of claim 1, including one or more tabs along a third edge and one or more corresponding slots along a fourth edge, wherein the interior volume is defined by mating the one or more tabs with respective ones of the one or more corresponding slots.

10. The track lighting module shroud of claim 1, including accessorizing mount mechanisms configured to accept accessories.

11. A track lighting module shroud mounted to an LED track lighting luminaire, the LED track lighting luminaire including an LED light head having a heat sink, the track lighting module shroud comprising:
a shell defining an interior volume, the shell including first and second edges at opposing ends of the shell;
the shell including a mount opening through the shell, the mount opening configured to align the shell with features of the LED track lighting luminaire; and
the interior volume sized to accommodate the heat sink.

12. The track lighting module shroud of claim 11, including an air inlet formed proximal to the first edge.

13. The track lighting module shroud of claim 12, including a thermal exit distal from the air inlet.

14. The track lighting module shroud of claim 11, including a thermal exit formed along the second edge.

15. The track lighting module shroud of claim 11, the mount opening located at a position on the shell that corresponds to a mounting arrangement of the LED light head.

16. The track lighting module shroud of claim 11, including a seam portion with opposing edges spaced apart at a distance configured to accept a mounting arrangement of the LED light head and the driver box.

17. The track lighting module shroud of claim 11, the shell formed from one of a sheet metal piece and a polymer.

18. The track lighting module shroud of claim 11, including one or more tabs along a third edge and one or more corresponding slots along a fourth edge, wherein the interior volume is defined by mating the one or more tabs with respective ones of the one or more corresponding slots.

19. The track lighting module shroud of claim 11, including accessorizing mount mechanisms configured to accept accessories.
